(19) United States
(12) Patent Application Publication
(10) Pub. No.: US 2003/0074825 A1
(43) Pub. Date: Apr. 24, 2003

(54) Three-dimensional camouflage leaves for concealment hunting

(76) Inventor: John Kevin Beaty, Alpharetta, GA (US)

Correspondence Address: JOHN KEVIN BEATY, 591 NORTH MAIN ST., ALPHARETTA, GA, 30004, US

(21) Appl. No.: 09/906,445

(22) Filed: Sep. 21, 2001

(51) Int. Cl. A01M 1/00

(52) U.S. Cl. 43/1

(57) ABSTRACT

The three dimensional camouflage system allows the hunter to quickly update his/her existing camouflage clothing. By a simple attachment of the elastic band and a quick selection of the limb to be inserted, the hunter breaks up his/her silhouette. The hunter's choice of limb and foliage adapts their existing clothing to match their immediate surroundings allowing them to go undetected by the prey animal they are hunting.

### THE FIGURE DESCRIPTION

In FIG. 1 on page one consists of a strap one (C) inch wide in three sections with a one (1) inch D ring attached on one end. Starting with the D ring, next is a four (4) inch long piece of black elastic doubled around the D ring with the loose ends sewn to a thirteen (13) inch long piece of soft velcro which is connected to a three (3) inch long piece of rough velcro. All three (3) sections and the D ring make a strap a total of eighteen and a half (18½) inches long.

FIG. 2 is a wire impregnated limb sixteen (16) inches long with five (5) smaller limbs (off shoots) bearing leaves on each side of the limb for a total of ten (10) small limbs with a varied number of leaves on each smaller limb varying in size and color.

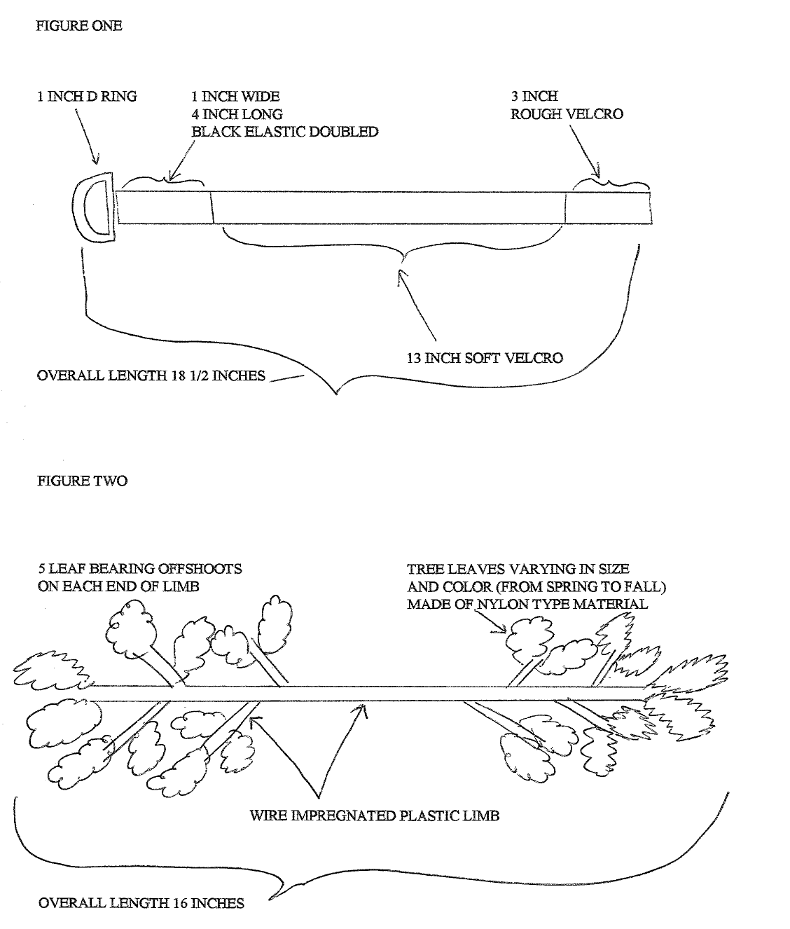

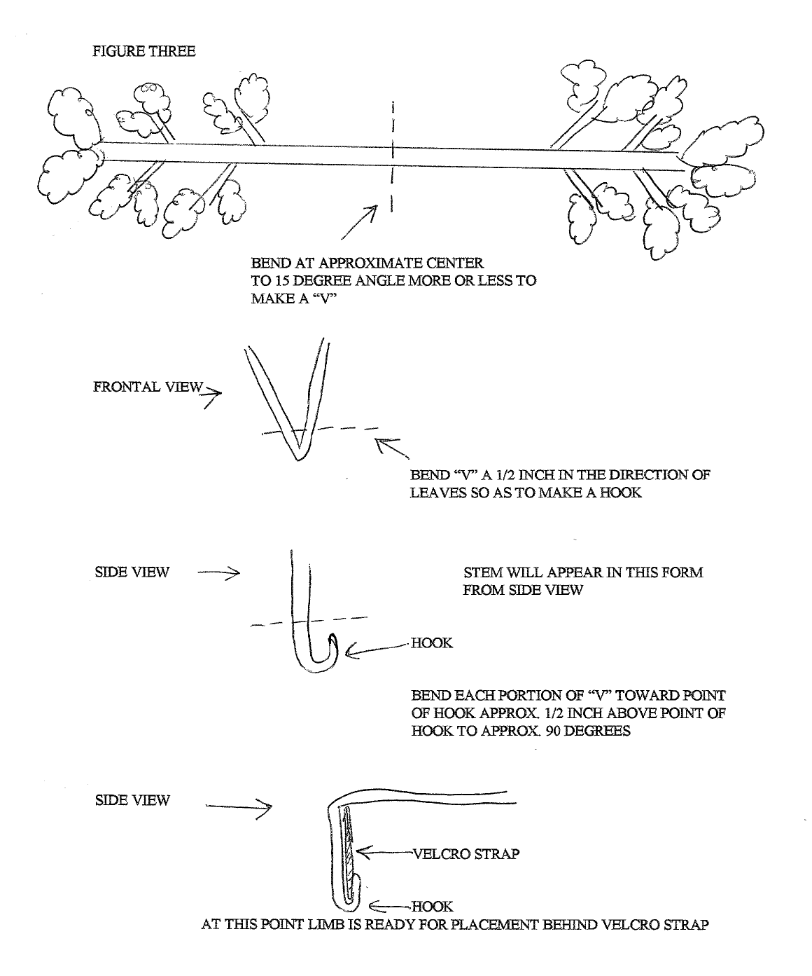

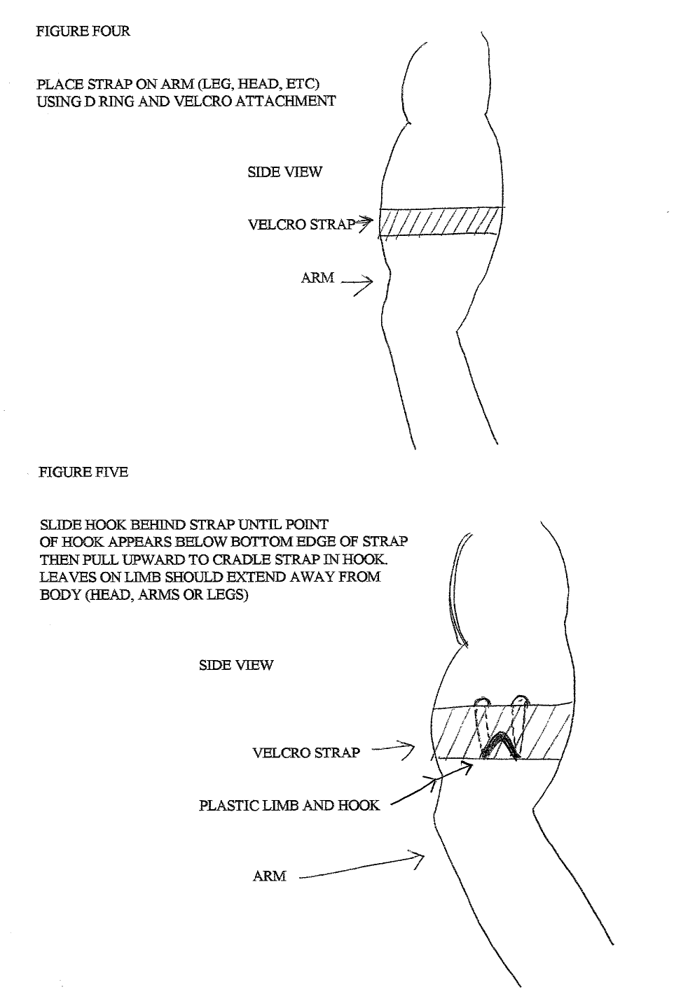

Page two FIG. 3 is directions of what to do with the limb from FIG. 2 to make the limb compatible with the strap from FIG. 1 page 1. Bend the main limb in the center to make a fifteen (15) degree angle more or less or a “V”. Next bend the bottom end of the “V” a half (½) inch from the point the “V” in the direction of the leaves to make a hook. Then bend each portion of the limb above the “V” a half (½) inch over the hook to a ninety (90) degree angle creating a cradle for the strap from page 1. At this point the limb is ready to be attached to the hunter's body with the strap from FIG. 1.

Page three FIG. 4 shows an arm, but the system will work on any part of the body, with the strap from Figure one on it.

FIG. 5 is showing how the limb in FIG. 3 will attach to the strap from Figure one after the bending technique from FIG. 3 page 2 is applied.

What I claim as my invention is:

1. A three dimensional camouflage system used for concealing the hunter.
This camouflage system is used by attaching an elastic band around any extremity.
The purpose of attaching the elastic band to one's body is to secure a wire impregnated limb.
The wire impregnated limb bears five (5) smaller limbs on each end.
Those five (5) smaller limbs bear foliage of one'choice.
The choice of foliage one selects to use would be determined by the season of the year and what type timber they are hunting in.
By attaching the leaf covered limb to one's body, it would break up the silhouette of the hunter thus allowing him/her to update their existing camouflage clothing.
